(19) United States
(12) Patent Application Publication
(10) Pub. No.: US 2014/0352563 A1
(43) Pub. Date: Dec. 4, 2014

(54) RESIN COMPOSITION FOR LASER ENGRAVING, FLEXOGRAPHIC PRINTING PLATE PRECURSOR FOR LASER ENGRAVING AND PROCESS FOR PRODUCING SAME, AND FLEXOGRAPHIC PRINTING PLATE AND PROCESS FOR MAKING SAME

(71) Applicant: FUJIFILM Corporation, Tokyo (JP)

(72) Inventor: Atsushi SUGASAKI, Haibara-gun (JP)

(73) Assignee: FUJIFILM Corporation, Tokyo (JP)

(21) Appl. No.: 14/294,927

(22) Filed: Jun. 3, 2014

(30) Foreign Application Priority Data
Jun. 4, 2013 (JP) 2013-117884

(51) Int. Cl. C08L 47/00; C08L 25/10; C08L 9/00; B23K 26/14; B05D 3/06; B05D 3/02; B23K 26/36; B41N 1/06; C08L 53/00

(52) U.S. Cl. CPC C08L 47/00; B41N 1/06; C08L 25/10; C08L 9/00; C08L 53/00; B05D 3/06; B05D 3/0254; B23K 26/365; B23K 26/1405; C08L 2207/04
USPC 101/395; 524/525; 524/505; 427/508; 427/385.5; 219/121.69

(57) ABSTRACT

Disclosed is a resin composition for laser engraving, comprising (Component A) a macromonomer comprising only one radically polymerizable group in the molecule, (Component B) a polyfunctional ethylenically unsaturated compound comprising two or more radically polymerizable groups in the molecule, (Component C) a binder polymer, and (Component D) a radical polymerization initiator.

### CROSS-REFERENCE TO RELATED APPLICATION

This application claims priority under 35 USC 119 from Japanese Patent Application No. 2013-117884 filed on Jun. 4, 2013, the disclosure of which is incorporated by reference herein.

### TECHNICAL FIELD

The present invention relates to a resin composition for laser engraving, a flexographic printing plate precursor for laser engraving and a process for producing the same, and a flexographic printing plate and a process for making the same.

### BACKGROUND ART

A large number of so-called “direct engraving CTP methods”, in which a relief-forming layer is directly engraved by means of a laser are proposed. In the method, a laser light is directly irradiated to a flexographic printing plate precursor to cause thermal decomposition and volatilization by photothermal conversion, thereby forming a concave part. Differing from a relief formation using an original image film, the direct engraving CTP method can control freely relief shapes. Consequently, when such image as an outline character is to be formed, it is also possible to engrave that region deeper than other regions, or, in the case of a fine halftone dot image, it is possible, taking into consideration resistance to printing pressure, to engrave while adding a shoulder. With regard to the laser for use in the method, a high-power carbon dioxide laser is generally used. In the case of the carbon dioxide laser, all organic compounds can absorb the irradiation energy and convert it into heat. On the other hand, inexpensive and small-sized semiconductor lasers have been developed, wherein, since they emit visible lights and near infrared lights, it is necessary to absorb a laser light and convert it into heat.

As a resin composition for laser engraving, those described in JP-A-2011-136430 (JP-A denotes a Japanese unexamined patent application publication), or JP-A-2011-148299 are known.

JP-A-2011-136430 describes, as a resin composition for laser engraving that can give a flexographic printing plate that is excellent in terms of film breaking strength and aqueous ink transfer properties and that is excellent in terms of rinsing properties for engraving residue generated when laser engraving a printing plate and engraving sensitivity in laser engraving, a resin composition for laser engraving comprising (Component A) a hydrolyzable silyl group- and/or silanol group-containing compound and, as (Component B) a binder polymer, a polyurethane.

JP-A-2011-148299 describes, as a resin composition for laser engraving that can give a flexographic printing plate that is excellent in terms of hardness, film elasticity, printing durability, and aqueous ink transfer properties and that is excellent in terms of rinsing properties for engraving residue generated when laser engraving a printing plate and engraving sensitivity in laser engraving, a resin composition for laser engraving comprising (Component A) a hydrolyzable silyl group- and/or silanol group-containing compound, (Component B) a thermoplastic elastomer, and (Component C) a polymerizable compound.

### DISCLOSURE OF THE PRESENT INVENTION

### Problems that the Present Invention is to Solve

It is an object of the present invention to provide a resin composition for laser engraving that can give a flexographic printing plate that is excellent in terms of engraved shape, ink laydown, and printing durability, a flexographic printing plate precursor for laser engraving employing the resin composition for laser engraving, a process for making a flexographic printing plate employing the flexographic printing plate precursor, and a flexographic printing plate obtained by the process.

### Means for Solving the Problems

The object of the present invention has been attained by means described in <1>, <11>, <12>, <14>, <16>, and <18> below. They are described below together with <2> to <10>, <13>, <15> and <17>, which are preferred embodiments.

<1> A resin composition for laser engraving, comprising (Component A) a macromonomer comprising only one radically polymerizable group in the molecule, (Component B) a polyfunctional ethylenically unsaturated compound comprising two or more radically polymerizable groups in the molecule, (Component C) a binder polymer, and (Component D) a radical polymerization initiator,
<2> the resin composition for laser engraving according to <1>, wherein Component A comprises a monomer unit derived from one type of ethylenically unsaturated compound selected from the group consisting of styrenes and (meth)acrylic acid esters,
<3> the resin composition for laser engraving according to <1> or <2>, wherein Component A has a weight-average molecular weight of at least 2,000 but no greater than 20,000,
<4> the resin composition for laser engraving according to any one of <1> to <3> above, wherein Component A has a glass transition temperature (Tg) of at least 20° C.,
<5> the resin composition for laser engraving according to any one of <1> to <4> above, wherein Component D is an organic peroxide,
<6> the resin composition for laser engraving according to any one of <1> to <5> above, wherein the radically polymerizable group of Component A is a (meth)acryloyl group at a molecular terminal,
<7> the resin composition for laser engraving according to any one of <1> to <6> above, wherein it further comprises (Component E) a photothermal conversion agent,
<8> the resin composition for laser engraving according to any one of <1> to <7> above, wherein Component C is a plastomer,
<9> the resin composition for laser engraving according to any one of <1> to <7> above, wherein Component C is a thermoplastic elastomer,
<10> the resin composition for laser engraving according to <7>, wherein Component D is an organic peroxide and Component E is carbon black,
<11> a flexographic printing plate precursor for laser engraving, comprising above a support a relief-forming layer comprising the resin composition for laser engraving according to any one of <1> to <10> above,
<12> a flexographic printing plate precursor for laser engraving, comprising above a support a crosslinked relief-forming layer formed by crosslinking by means of heat and/or light a relief-forming layer comprising the resin composition for laser engraving according to any one of <1> to <10> above,
<13> the flexographic printing plate precursor for laser engraving according <12>, wherein it comprises a crosslinked relief-forming layer that has been crosslinked by means of heat,
<14> a process for producing a flexographic printing plate precursor for laser engraving, comprising a layer formation step of forming a relief-forming layer comprising the resin composition for laser engraving according to any one of <1> to <10> above, and a crosslinking step of crosslinking the relief-forming layer by means of heat and/or light to thus obtain a flexographic printing plate precursor comprising a crosslinked relief-forming layer,
<15> the process for producing a flexographic printing plate precursor for laser engraving according to <14>, wherein in the crosslinking step the relief-forming layer is crosslinked by means of heat,
<16> a process for making a flexographic printing plate, comprising a step of preparing the flexographic printing plate precursor for laser engraving according to any one of <11> to <13> above, and an engraving step of laser-engraving the flexographic printing plate precursor for laser engraving to thus form a relief layer,
<17> the process for making a flexographic printing plate according to <16>, wherein subsequent to the engraving step it further comprises a rinsing step of rinsing a surface of the relief layer with an aqueous rinsing liquid,
<18> a flexographic printing plate made by the process according to <16> or <17>.

### MODE FOR CARRYING OUT THE INVENTION

### (Resin Composition for Laser Engraving)

The resin composition for laser engraving of the present invention (hereinafter, also simply called a ‘resin composition’) comprises (Component A) a macromonomer comprising only one radically polymerizable group in the molecule, (Component B) a polyfunctional ethylenically unsaturated compound comprising two or more radically polymerizable groups in the molecule, (Component C) a binder polymer, and (Component D) a radical polymerization initiator.

The resin composition for laser engraving of the present invention may be used, without any particular limitations, in a wide range of applications in addition to formation of a relief-forming layer of a flexographic printing plate precursor, which is subjected to laser engraving. For example, it may be applied not only to a relief-forming layer of a printing plate precursor in which formation of a raised relief, which is described in detail below, is carried out by laser engraving but also to formation of other material shapes forming asperities and openings on the surface, for example, various types of printing plates and various types of moldings in which formation of a required image is carried out by laser engraving, such as an intaglio plate, a stencil plate, or a stamp.

The resin composition of the present invention is preferably used for forming a relief-forming layer above an appropriate support, thus giving a flexographic printing plate precursor for laser engraving.

In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit. In addition, ‘mass %’ and ‘parts by mass’ have the same meanings as ‘wt %’ and ‘parts by weight’ respectively.

Furthermore, ‘(Component A) a macromonomer comprising only one radically polymerizable group in the molecule’ etc. are simply called ‘Component A’ etc.

In the present invention, a combination of preferred embodiments is more preferable.

As a result of an intensive investigation by the present inventors, it has been found that, due to the resin composition for laser engraving comprising Component A, Component B, Component C, and Component D in combination, the sharpness of a laser-engraved relief engraved shape, ink laydown, and printing durability are excellent.

Although the detailed mechanism is unclear, when the resin composition is subjected to radical polymerization by the action of Component D, Component A and Component B are copolymerized in the presence of Component C, thus forming an overall crosslinked net structure. It is surmised that, in the net structure (sea) containing Component C, hydrophobic long side chains of Component A gather together to thus form microscopic independent regions (islands). It is surmised that, when the resin composition of the present invention is subjected to radical polymerization, a so-called ‘sea-island structure (microphase separation structure)’ is thus formed. Furthermore, there is a strong tendency for a Component A-derived monomer unit to localize in the ‘islands’, and this tendency is obvious when Component A comprises a molecular chain having a high glass transition temperature (Tg). It is surmised that due to these ‘island’ regions being formed, degradation of the engraved shape caused by thermal melting is suppressed, and because of the presence of the ‘sea’ region, which is flexible, the rubber elasticity of the entire resin can be maintained, thus attaining the object of the present invention.

In the present invention, when explaining the flexographic printing plate precursor for laser engraving, a layer having a flat surface for image formation that is obtained by radical polymerization of the resin composition and that is to be subjected to laser engraving is called a relief-forming layer and a layer obtained by subjecting this to laser engraving to form asperities on the surface is called a relief layer.

(Component A) a macromonomer comprising only one radically polymerizable group in the molecule, (Component B) a polyfunctional ethylenically unsaturated compound comprising two or more radically polymerizable groups in the molecule, (Component C) a binder polymer, and (Component D) a radical polymerization initiator, which are essential components of the resin composition of the present invention, are explained in sequence below.

### (Component A) Macromonomer Comprising Only One Radically Polymerizable Group in Molecule

Component A comprises a ‘radically polymerizable group’, that is, a group that undergoes addition polymerization via a radical growth terminal, and Component A is a so-called monofunctional monomer comprising ‘only one’ of such a radically polymerizable functional group in the molecule, and has a relatively high molecular weight. The macromonomer referred to here means one having a weight-average molecular weight of at least 1,000, and is preferably one of no greater than 100,000. A more preferred range is described later.

It is preferable that said only one radically polymerizable group is present not in the interior of the molecule but at a molecular terminal in order for its radical polymerizability to be exhibited.

One method for introducing such a radically polymerizable group at a molecular terminal is a polymer reaction method in which introduction is carried out by utilizing a reaction between (meth)acryloyl chloride, etc. and a functional group such as a hydroxy group that is present on its own at a molecular terminal.

As an alternative method, a macromonomer may be produced by a radical polymerization method at high temperature.

A macromonomer formed by any method may be used in the present invention, but a macromonomer produced by a polymer reaction method is preferably used in the present invention.

The radically polymerizable group of Component A is preferably an ethylenically unsaturated group, and more preferably one represented by Formula (1) or (2).

—C(═O)C(R)═CH₂ (1)

—C(═CH₂)C(═O)O(R) (2)

In the Formulae, R denotes a hydrogen atom or a monovalent organic group having 1 to 20 carbons.

In Formula (1), R is preferably a lower alkyl group (1 to 5 carbons) or a hydrogen atom, and more preferably a hydrogen atom or a methyl group. That is, a group represented by Formula (1) is preferably a (meth)acryloyl group. Furthermore, the radically polymerizable group is more preferably a (meth)acryloyloxy group.

In Formula (2), R also has the same meaning as that for Formula (1) and is preferably a hydrogen atom or a methyl group. That is, a group represented by Formula (2) is preferably a (1-hydroxycarbonyl)vinyl group or a (1-methoxycarbonyl)vinyl group.

The ‘macromonomer’ in the present invention preferably comprises a radically polymerizable group at one terminal of a chain-form molecule. In the macromonomer, the part other than the ethylenically unsaturated group is a long chain skeleton, preferably comprises an ethylenically unsaturated compound-derived monomer unit, and is preferably hydrophobic rather than hydrophilic. This long chain skeleton is preferably derived from a monomer unit that gives a glass transition temperature (Tg) for Component A of at least 20° C. An ethylenically unsaturated compound that gives such a monomer unit is preferably selected from a styrene and a (meth)acrylic acid ester, is more preferably derived from styrene or methyl methacrylate, and is yet more preferably derived from styrene.

Examples of styrenes include styrene, vinyltoluene, α-methylstyrene, chlorostyrene, styrenesulfonic acid, and salts thereof; styrene is preferable since it gives a high Tg.

Examples of the (meth)acrylic acid ester include methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl)trimethoxysilane, an ethylene oxide adduct of (meth)acrylic acid, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, perfluoroethyl (meth)acrylate, perfluoromethyl (meth)acrylate, diperfluoromethylmethyl (meth)acrylate, perfluoromethylperfluoroethylmethyl (meth)acrylate, 2-perfluorohexylethyl (meth)acrylate, 2-perfluorodecylethyl (meth)acrylate, and 2-perfluorohexadecylethyl (meth)acrylate. The alcohol component of a (meth)acrylic acid ester is preferably a methyl group or a hydroxyethyl group and, from the viewpoint of a high Tg being given, an ester of methacrylic acid is preferable.

The long chain skeleton of Component A may comprise one type of monomer unit or may comprise two or more types of monomer units.

Furthermore, Component A preferably comprises at least 50 mole % of a styrene- or methyl (meth)acrylate-derived monomer unit relative to the entire monomer units, more preferably at least 80 mole %, yet more preferably at least 90 mole %, and particularly preferably at least 95 mole %.

The macromonomer as Component A may be selected from a large number of commercially available products.

Macromonomers in which the long-chain molecular chain of the macromonomer is polymethyl methacrylate (MMA), polybutyl acrylate, polystyrene (St), poly(acrylonitrile-styrene) (AN/St), poly(2-hydroxyethyl methacrylate) (MMA/HEMA), or polyisobutyl methacrylate (IBMA) are commercially available from Toagosei Co., Ltd. under various grade names and may be used in the present invention.

The grade names of products sold by Toagosei Co., Ltd. include 45% AA-6, AA-6SR, AA-6, AS-6, AN-6S, AB-6, AW-6S, AK-5, and AK-32.

Component A preferably has a weight-average molecular weight of 2,000 to 100,000, more preferably 4,000 to 40,000, and yet more preferably 5,000 to 20,000. When in this molecular weight range, a microphase separation structure tends to be easily formed. The weight-average molecular weight (Mw) of a resin, etc. in the present invention may be measured for example using gel permeation chromatography (GPC) and determined by calibrating and converting the measured value using a polystyrene with a known molecular weight.

With regard to Component A in the resin composition of the present invention, only one type thereof may be used or two or more types may be used in combination.

The content of Component A contained in the resin composition of the present invention is preferably 1 to 30 mass % relative to the solids content total mass, which excludes volatile components such as solvent, is more preferably 5 to 20 mass %, and is yet more preferably 10 to 20 mass %.

Furthermore, the macromonomer of the present application preferably has a glass transition temperature (Tg) of at least 20° C. as described above. The glass transition temperature may be measured by differential scanning calorimetry measurement (DSC measurement).

The ‘glass transition temperature’ of a polymer in a macromonomer whose long chain skeleton is a copolymer may be calculated from the FOX equation below (Formula (3)). The Tg used in Formula (3) means the absolute temperature (K), but the Tg used elsewhere in the specification means the Celsius temperature (° C.).

1/Tg=W₁/Tg₁+W₂/Tg₂+ . . . +Wᵢ/Tgᵢ++Wₙ/Tgₙ (3)

In the FOX equation, the glass transition temperature of a homopolymer formed from each monomer forming a polymer derived from n types of monomers is Tgᵢ, and the mass fraction of each monomer is Wᵢ (W₁+W₂+ . . . +Wᵢ+ . . . +Wₙ=1).

### (Component B) Polyfunctional Ethylenically Unsaturated Compound Comprising Two or More Radically Polymerizable Groups in Molecule

Component B used in the present invention is a polyfunctional ethylenically unsaturated compound comprising two or more radically polymerizable groups in the molecule. The number of radically polymerizable groups of Component B is preferably 2 to 20, more preferably 2 to 6, and particularly preferably 2.

Component B is preferably a polymerizable compound having a molecular weight of less than 1,000, and its (weight-average) molecular weight is more preferably 170 to 900.

Such polyfunctional ethylenically unsaturated compounds are widely known in this industrial field and can be used in the present invention without particular limitation. Component B includes an ethylenically unsaturated group-containing carboxylic acid, an ester obtained by a reaction between a polyhydric alcohol (polyol) and an ethylenically unsaturated group-containing carboxylic acid (derivative), an amide obtained by a reaction between a polyvalent amine (polyamine) and an ethylenically unsaturated group-containing carboxylic acid, a polyfunctional vinyl ether, and a polyfunctional allyl compound. Detailed explanation is given below.

Examples of the polyfunctional ethylenically unsaturated compound include an unsaturated carboxylic acid (e.g. acrylic acid, methacrylic acid, itaconic acid, crotonic acid, isocrotonic acid, maleic acid, etc.), an ester thereof, and an amide thereof; it is preferable to use an ester between an unsaturated carboxylic acid and an aliphatic polyhydric alcohol compound or an amide between an unsaturated carboxylic acid and an aliphatic polyvalent amine compound.

Preferred examples of the aliphatic polyhydric alcohol include an alkylenediol having 2 to 10 carbons, trimethylolpropane, pentaerythritol, dipentaerythritol, and tricyclodecanedimethanol.

Furthermore, an addition reaction product of an unsaturated carboxylic acid ester or amide having a nucleophilic substituent such as a hydroxy group or an amino group with a polyfunctional isocyanate or epoxy, and a dehydration-condensation reaction product thereof with a polyfunctional carboxylic acid, etc. are also suitably used. Moreover, an addition reaction product of an unsaturated carboxylic acid ester or amide having an electrophilic substituent such as an isocyanate group or an epoxy group with a monofunctional or polyfunctional alcohol or amine and a substitution reaction product between an unsaturated carboxylic acid ester or amide having a leaving substituent such as a halogen atom or a tosyloxy group and a monofunctional or polyfunctional alcohol or amine are also suitable. As alternative examples, a group of compounds formed by replacing the unsaturated carboxylic acid with a vinyl compound, an allyl compound, an unsaturated phosphonic acid, styrene, etc. may also be used.

From the viewpoint of reactivity, the radically polymerizable group contained in the polyfunctional ethylenically unsaturated compound is preferably a (meth)acryloyl group, more preferably a (meth)acryloyloxy group, and particularly preferably an acryloyl group.

Specific examples of ester monomers comprising an ester of an aliphatic polyhydric alcohol compound and an unsaturated carboxylic acid include acrylic acid esters such as ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, and a polyester acrylate oligomer.

Examples of methacrylic acid esters include tetramethylene glycol dimethacrylate, triethylene glycol dimethacrylate, neopentyl glycol dimethacrylate, trimethylolpropane trimethacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane, and bis[p-(methacryloxyethoxy)phenyl]dimethylmethane.

Examples of itaconic acid esters include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid esters include ethylene glycol dicrotonate, tetramethylene glycol dicrotonate, pentaerythritol dicrotonate, and sorbitol tetracrotonate.

As isocrotonic acid esters there can be cited ethylene glycol diisocrotonate, pentaerythritol diisocrotonate, and sorbitol tetraisocrotonate.

As maleic acid esters there can be cited ethylene glycol dimaleate, triethylene glycol dimaleate, pentaerythritol dimaleate, and sorbitol tetramaleate.

As examples of other esters, aliphatic alcohol-based esters described in JP-B-46-27926 (JP-B denotes a Japanese examined patent application publication), JP-B-51-47334 and JP-A-57-196231, those having an aromatic skeleton described in JP-A-59-5240, JP-A-59-5241, and JP-A-2-226149, those having an amino group described in JP-A-1-165613, etc. may also be used preferably.

The above-mentioned ester monomers may be used as a mixture.

Furthermore, specific examples of amide monomers including an amide of an aliphatic polyamine compound and an unsaturated carboxylic acid include methylenebisacrylamide, methylenebismethacrylamide, 1,6-hexamethylenebisacrylamide, 1,6-hexamethylenebismethacrylamide, diethylenetriaminetrisacrylamide, xylylenebisacrylamide, and xylylenebismethacrylamide.

Furthermore, a urethane-based addition-polymerizable compound produced by an addition reaction of an isocyanate and a hydroxy group is also suitable, and specific examples thereof include a polyfunctional ethylenically unsaturated compound in which a hydroxy group-containing ethylenically unsaturated compound represented by Formula (4) below is added to a polyisocyanate compound having two or more isocyanate groups per molecule described in JP-B-48-41708.

CH₂═C(R)COOCH₂CH(R′)OH (4)

wherein R and R′ independently denote H or CH₃.

Furthermore, urethane acrylates described in JP-A-51-37193, JP-B-2-32293, and JP-B-2-16765, and urethane compounds having an ethylene oxide-based skeleton described in JP-B-58-49860, JP-B-56-17654, JP-B-62-39417, JP-B-62-39418 are also suitable.

Furthermore, by use of an addition-polymerizable compound having an amino structure in the molecule described in JP-A-63-277653, JP-A-63-260909, and JP-A-1-105238, a resin composition having excellent curing speed can be obtained.

Other examples include polyester acrylates such as those described in JP-A-48-64183, JP-B-49-43191, and JP-B-52-30490, and polyfunctional acrylates and methacrylates such as epoxy acrylates formed by a reaction of an epoxy resin and (meth)acrylic acid. Examples also include specific unsaturated compounds described in JP-B-46-43946, JP-B-1-40337, and JP-B-1-40336, and vinylphosphonic acid-based compounds described in JP-A-2-25493. In some cases, perfluoroalkyl group-containing structures described in JP-A-61-22048 are suitably used. Moreover, those described as photocuring monomers or oligomers in the Journal of the Adhesion Society of Japan, Vol. 20, No. 7, pp. 300 to 308 (1984) may also be used.

Examples of the vinyl compounds include butanediol-1,4-divinyl ether, ethylene glycol divinyl ether, 1,2-propanediol divinyl ether, 1,3-propanediol divinyl ether, 1,3-butanediol divinyl ether, 1,4-butanediol divinyl ether, neopentyl glycol divinyl ether, trimethylolpropane tirvinyl ether, trimethylolethane tirvinyl ether, hexanediol divinyl ether, tetraethylene glycol divinyl ether, pentaerythritol divinyl ether, pentaerythritol tirvinyl ether, pentaerythritol tetravinyl ether, sorbitol tetravinyl ether, sorbitol pentavinyl ether, ethylene glycol diethylenevinyl ether, ethylene glycol dipropylenevinyl ether, trimethylolpropane triethylenevinyl ether, trimethylolpropane diethylenevinyl ether, pentaerythritol diethylenevinyl ether, pentaerythritol triethylenevinyl ether, pentaerythritol tetraethylenevinyl ether, 1,1,1-tris[4-(2-vinyloxyethoxy)phenyl]ethane, bisphenol A divinyloxyethyl ether, divinyl adipate, etc.

Examples of the allyl compounds include polyethylene glycol diallyl ether, 1,4-cyclohexane diallyl ether, 1,4-diethylcyclohexyl diallyl ether, 1,8-octane diallyl ether, trimethylolpropane diallyl ether, trimethylolethane triallyl ether, pentaerythritol triallyl ether, pentaerythritol tetraallyl ether, dipentaerythritol pentaallyl ether, dipentaerythritol hexaallyl ether, diallyl phthalate, diallyl terephthalate, diallyl isophthalate, triallyl isocyanurate, triallyl phosphate, etc.

Among them, Component B is preferably an ester between an aliphatic polyhydric alcohol compound and (meth)acrylic acid; preferred examples include diethylene glycol di(meth)acrylate, dipentaerythritol hexa(meth)acrylate, tricyclodecanedimethanol di(meth)acrylate, trimethylolpropane tri(meth)acrylate, pentaerythritol tetra(meth)acrylate, and 1,6-hexanediol di(meth)acrylate.

Furthermore, Component B may be a commercially available product, and examples thereof include hexanediol diacrylate (Dai-Ichi Kogyo Seiyaku Co., Ltd.) and trimethylolpropane triacrylate (Shin-Nakamura Chemical Co., Ltd.).

With regard to Component B, one type thereof may be used on its own or two or more types may be used in combination.

The content of Component B is preferably 3 to 60 mass % relative to the solids content total mass of the resin composition for laser engraving, more preferably 8 to 30 mass %, and particularly preferably 10 to 20 mass %.

### (Component C) Binder Polymer

The resin composition of the present invention comprises as an essential component (Component C) a binder polymer. The binder polymer is a binding resin and may have a so-called internal olefinic bond.

It is preferable for Component C not to have an ethylenically unsaturated group at a main chain terminal, but it may have an ethylenically unsaturated group at a position other than a molecular terminal. Component C preferably has a weight-average molecular weight of at least 1,000 but no greater than 1,000,000, and more preferably 2,000 to 500,000.

As the binder polymer, a usual polymer compound may be selected as appropriate; one type may be used on its own or two or more types may be used in combination, and selection is preferably carried out while taking into consideration various performance aspects such as, in particular, laser engraving properties, ink transfer properties, and engraving residue dispersibility.

The binder polymer may be selected from a polystyrene resin, a polyester resin, a polyamide resin, a polysulfone resin, a polyether sulfone resin, a polyimide resin, a styrene-butadiene resin, an acrylic resin, an acetal resin, an epoxy resin, a polycarbonate resin, and a polyconjugated diene resin, and it is preferable to use a plastomer or a thermoplastic elastomer.

In the resin composition for laser engraving of the present invention, (Component C) binder polymer is preferably a plastomer.

The term ‘plastomer’ as used in the present invention means, as described in ‘Shinpan Kobunshi Jiten (Newly-published Polymer Encyclopedia)’ edited by the Society of Polymer Science, Japan (published in 1988 by Asakura Publishing Co., Ltd., Japan), a macromolecule which has a property of easily undergoing fluid deformation by heating and being capable of solidifying into a deformed shape by cooling. The term ‘plastomer’ is a term opposed to the term ‘elastomer’ (a polymer having a property of, when an external force is added, instantaneously deforming in accordance with the external force, and when the external force is removed, being restored to the original shape in a short time), and the plastomer does not exhibit the same elastic deformation as that exhibited by an elastomer, and easily undergoes plastic deformation.

In the present invention, a plastomer means a polymer which, when the original size is designated as 100%, can be deformed up to 200% of the original size by a small external force at room temperature (20° C.), and even if the external force is removed, does not return to 130% or less of the original size. More particularly, the plastomer means a polymer with which, based on the tensile permanent strain test of JIS K 6262-1997, an I-shaped specimen can be extended to 2 times the gauge length before pulling in a tensile test at 20° C., and the tensile permanent strain measured after extending the specimen to 2 times the gauge length before pulling, subsequently maintaining the specimen for 5 minutes, removing the external tensile force, and maintaining the specimen for 5 minutes, is 30% or greater.

Meanwhile, in the case of a polymer that cannot be subjected to the measurement described above, a polymer which is deformed even if an external force is not applied and does not return to the original shape, corresponds to a plastomer, and for example, a syrup-like resin, an oil-like resin, and a liquid resin correspond thereto.

Furthermore, when a glass transition temperature (Tg) of the polymer can be measured, at least one Tg of the plastomer is preferably less than 20° C.

The viscosity at 20° C. of the plastomer in the present invention is preferably 0.5 Pa·s to 10 kPa·s, more preferably 10 Pa·s to 10 kPa·s, and yet more preferably 50 Pa·s to 5 kPa·s. When the viscosity is in this range, it is easy to shape the resin composition into a sheet-form or cylindrical printing plate precursor, and processing is also simple. In the present invention, due to Component C being a plastomer, when shaping the printing plate precursor for laser engraving obtained therefrom into a sheet shape or a cylindrical shape, good thickness precision or dimensional precision can be achieved.

In particular, when a flexible relief image is required, as for the flexographic printing plate application, it is preferable in one embodiment of the resin composition to use a plastomer as Component C. Examples of such a plastomer include a polyolefin resin such as polyethylene, a polyconjugated diene-based resin such as polybutadiene, hydrogenated polybutadiene, polyisoprene, or hydrogenated polyisoprene, a polyester such as polycaprolactone, a polyether such as polyethylene glycol, polypropylene glycol, or polytetramethylene glycol, an aliphatic polycarbonate, a silicone such as polydimethylsiloxane, a homopolymer or copolymer of (meth)acrylic acid and/or a derivative thereof, and a mixture of the above; among them the plastomer is preferably a polyconjugated diene-based resin, and more preferably polybutadiene or polyisoprene. The polybutadiene and the polyisoprene may be hydrogenated.

The polybutadiene may be a polymer comprising butadiene as a monomer unit of the main chain, and includes terminal-modified polybutadiene, partially hydrogenated polybutadiene, and hydrogenated polybutadiene. A commercially available polybutadiene or polybutadiene polyol may be used, and examples thereof include the Kuraprene LBR series (Kuraray Co., Ltd.), Poly bd (Idemitsu Kosan Co., Ltd.), and the UBEPOL series (Ube Industries, Ltd.).

The polyisoprene may be a polymer comprising isoprene as a monomer unit of the main chain, and includes terminal-modified polyisoprene, partially hydrogenated polyisoprene, and hydrogenated polyisoprene. A commercially available polyisoprene or polyisoprene polyol may be used, and examples thereof include the Kuraprene LIR series (Kuraray Co., Ltd.).

It is preferable for both the polybutadiene and the polyisoprene to comprise a 1,4-adduct as a main component.

Moreover, the polybutadiene and the polyisoprene both preferably have a number-average molecular weight of 1,500 to 500,000, more preferably 2,000 to 300,000, and yet more preferably 2,500 to 250,000.

Furthermore, in another embodiment of the resin composition for laser engraving of the present invention, the binder polymer (Component C) is preferably a thermoplastic elastomer. The thermoplastic elastomer is a material that is plasticized and flows at high temperature and exhibits rubber elasticity at normal temperature. The thermoplastic elastomer forms a finely dispersed multi-phase structure at normal temperature. In a majority of thermoplastic elastomers, the respective phases are chemically bonded as a result of block copolymerization or graft copolymerization. When there is no chemical bonding a sufficiently finely dispersed state is formed.

Component C is preferably a thermoplastic elastomer in which several segments are chemically bonded, and is more preferably a block copolymer. The molecular structure of the block copolymer comprises a soft segment such as a polyether or rubber molecule and a hard segment that does not exhibit plastic deformation at around normal temperature, as in vulcanized rubber. It forms a multi-phase structure in which the hard segment phase and the soft segment phase are finely dispersed. As a phase formed from the hard segment, there are various types such as a frozen phase, a crystalline phase, a hydrogen-bonded phase, and an ionically-crosslinked phase.

Such a thermoplastic elastomer exhibits rubber elasticity at normal temperature. When a thermoplastic elastomer is used as Component C, a flexographic printing plate formed from the resin composition can deform according to asperities of a printed material during printing, ink laydown is excellent, and since its original shape is restored after it separates from the printed material, printing durability is excellent. Furthermore, since a thermoplastic elastomer exhibits flowability upon heating, handling such as mixing of materials is easy. For the above reasons, a thermoplastic elastomer is suitable when the resin composition for laser engraving of the present invention is applied to the production of a flexographic printing plate where the flexographic printing plate is required to have flexibility.

From the viewpoint of printing durability and hardness of a flexographic printing plate, the proportion of the hard segment in the thermoplastic elastomer is preferably 10 to 70 mass %, more preferably 15 to 60 mass %, and yet more preferably 30 to 50 mass %.

From the viewpoint of flexibility and rubber elasticity being exhibited, the thermoplastic elastomer is preferably a polymer having a glass transition temperature (Tg) of no greater than 20° C., and more preferably no greater than 0° C. From the viewpoint of printing durability, the thermoplastic elastomer is preferably a polymer having a melting point (Tm) of at least 70° C., and more preferably at least 100° C.

Examples of the thermoplastic elastomer include an acrylic thermoplastic elastomer, a styrene-based thermoplastic elastomer, an ester-based thermoplastic elastomer, an olefin-based thermoplastic elastomer, an amide-based thermoplastic elastomer, a silicone-based thermoplastic elastomer, a vinyl chloride-based thermoplastic elastomer, a nitrile-based thermoplastic elastomer, a fluorine-based thermoplastic elastomer, and a crosslinked chlorinated polyethylene; among them an acrylic thermoplastic elastomer and a styrene-based thermoplastic elastomer are preferable, and a block copolymer comprising a poly(meth)acrylate or polystyrene block is more preferable. The thermoplastic elastomer in the present invention does not include natural rubber. For the purpose of improving laser engraving sensitivity of these thermoplastic elastomers, a readily decomposable functional group such as a carbamoyl group or a carbonate group may be introduced into the main chain of the elastomer. One in which a thermoplastic polymer and a polymer having a readily decomposable functional group introduced thereinto are mixed may also be used.

### (Acrylic Thermoplastic Elastomer)

Examples of the acrylic thermoplastic elastomer include a block copolymer (hereinafter, also called an acrylic block copolymer) comprising a polymer block comprising an acrylic monomer-derived monomer unit as a main component (hard segment) and a block comprising a conjugated diene compound-derived monomer unit as a main component (soft segment) and one obtained by hydrogenating the conjugated diene compound-derived monomer unit of the above block copolymer.

Being ‘acrylic’ in the present invention means comprising at least one type of constituent unit derived from a monomer selected from the group consisting of acrylic acid, methacrylic acid, fumaric acid, maleic acid, esters thereof, acrylamide, methacrylamide, and derivatives thereof.

The acrylic block copolymer may have two or more types of blocks, and although it may have three or more types of blocks, it preferably has 2 to 4 types, more preferably 2 or 3, and yet more preferably 2 types. Moreover, for example, when it is an A-B-A type block copolymer described later, there are two types of blocks.

Moreover, the acrylic block copolymer may have one or more type of acrylic block, further, although it may have a block other than acrylic, such as an aromatic vinyl polymer block, a conjugated diene polymer block, and a hydrogenation conjugated diene polymer block, it is preferred that the acrylic block copolymer is a copolymer which includes only two or more types of acrylic blocks.

Moreover, when the acrylic block copolymer has two or more blocks which include monomer units of the same type, these may be the same molecular weight (a weight average molecular weight), or different from each other, also, a molecular structure, such as a composition ratio of a monomer unit, an arrangement state, solid arrangement, and a crystal structure, may be the same as or different from each other.

The monomer unit in each block of the acrylic block copolymer may be even one type on its own, and it may have two or more types. For example, although each block of the acrylic block copolymer may be a homopolymer, or a random copolymer, respectively, it is preferable that each block of Component A be a homopolymer, respectively.

When different types of blocks are denoted by A, B, and C, examples of the acrylic block copolymer include an A-B type diblock copolymer; A-B-A type, B-A-B type, A-B-C type, B-A-C type, and B-C-A type triblock copolymers; (A-B)ₙ type, (A-B-)ₙA type, and (B-A-)ₙB type straight-chain polyblock copolymers; (A-B-)ₙX type (X denotes a coupling residue), (B-A-)ₙX type, (A-B-A)ₙX type, (A-C-B)ₙX type, (B-C-A)ₙX type, (A-B-C)ₙX type, (C-B-A-)ₙX type, and (C-A-B-)ₙX type star block copolymers (in the Formulae, n denotes an integer of 2 or greater); and a comb-shaped block copolymer.

The acrylic block copolymer in the resin composition for laser engraving of the present invention may be used as one type on its own or may be used by mixing of two or more types.

Since the acrylic block copolymer has excellent flexibility of the cured resin and production is easy, a triblock copolymer of A-B-A type and a diblock copolymer of A-B type are preferred, and a triblock copolymer of A-B-A type is particularly preferable.

The ratio of the monomer units represented by the following Formula (C-1) in a single block of the acrylic block copolymer with respect to the total weight of the block is preferably 80 mass % or more, more preferably 90 mass % by weight or more, and particularly preferably 95 to 100 mass %.

Moreover, Component A is more preferably having at least a block consisting of monomer units represented by the following Formula (C-1), and particularly preferably a block copolymer including only the blocks which consisting of monomer units represented by two or more types of the following Formula (C-1).

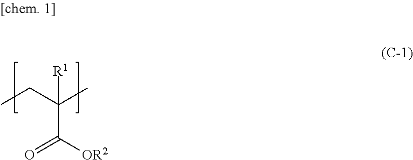

In the formula, R¹ represents a hydrogen atom or a methyl group, and R² represents an alkyl group, a hydroxyalkyl group, an alkoxyalkyl group, a polyalkyleneoxyalkyl group, an aralkyl group, an allyl group or a dialkylaminoalkyl group. The number of carbon atoms of R² is 2 to 20.

R¹ in Formula (C-1), from the viewpoint of uniformity at the time of the synthesis and the like, is preferably only either a hydrogen atom or a methyl group in one type of block in the acrylic block copolymer.

R² in Formula (C-1) preferably has 1 to 16 carbon atoms, more preferably 1 to 12 carbon atoms, and particularly preferably 1 to 8 carbon atoms.

Moreover, R² in the formula (C-1), from the viewpoint of compatibility with the plasticizer and crosslinking agent which coexist in a film, is preferably an alkyl group or a hydroxyalkyl group, particularly preferably an alkyl group. In addition, an alkyl group, a hyroxyalkyl group, an alkoxyalkyl group, a polyalkyleneoxyalkyl group, an aralkyl group, and a dialkylaminoalkyl group in the above R² may have a straight chain, branched, or ring structure.

As a monomer which forms the monomer unit represented by above Formula (C-1), compounds represented by the following Formula (C′-1) are included.

R¹ and R² in following Formula (C′-1) have the same definitions as R¹ and R² in the above formula (C-1), respectively, and preferable aspects are also the same.

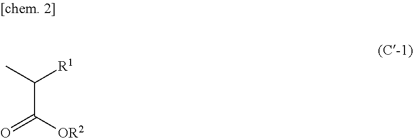

In the formula, R¹ represents a hydrogen atom or a methyl group, and R² represents an alkyl group, a hydroxyalkyl group, an alkoxyalkyl group, a polyalkyleneoxyalkyl group, an aralkyl group, an allyl group or a dialkylaminoalkyl group.

The acrylic block copolymer, from the viewpoints such as the ease of performing block copolymerization and ease of controlling of the ink transfer properties of an obtained block copolymer or film flexibility, it is preferably a block copolymer obtained by copolymerization of at least two types selected from the following monomer group.

Examples include 2-hydroxyethyl (meth)acrylate, 2-hydroxypropyl (meth)acrylate, 4-hydroxybutyl (meth)acrylate, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, 2-ethylhexyl (meth)acrylate, acetoxyethyl (meth)acrylate, phenyl (meth)acrylate, 2-methoxyethyl (meth)acrylate, 2-ethoxyethyl (meth)acrylate, 2-(2-methoxyethoxy)ethyl (meth)acrylate, cyclohexyl (meth)acrylate, benzyl (meth)acrylate, diethylene glycol monomethyl ether (meth)acrylate, diethylene glycol monoethyl ether (meth)acrylate, diethylene glycol monophenyl ether (meth)acrylate, triethylene glycol monomethyl ether (meth)acrylate, triethylene glycol monoethyl ether (meth)acrylate, dipropylene glycol monomethyl ether (meth)acrylate, polyethylene glycol monomethyl ether (meth)acrylate, polypropylene glycol monomethyl ether (meth)acrylate, monomethyl ether (meth)acrylate of the copolymer of ethylene glycol and propylene glycol, N,N-dimethylaminoethyl (meth)acrylate, N, N-diethylaminoethyl (meth)acrylate, N,N-dimethylaminopropyl (meth)acrylate, and the like. Furthermore, the modified acrylic resin which comprises the acrylic monomer having a urethane group or a urea group can also be used preferably.

Among these, as a monomer to synthesize the acrylic block copolymer, from the viewpoint of printing durability, 2-hydroxyethyl (meth)acrylate, 2-hydroxypropyl (meth)acrylate, 4-hydroxybutyl (meth)acrylate, methyl (meth)acrylate, ethyl (meth)acrylate, n-propyl (meth)acrylate, isopropyl (meth)acrylate, and n-butyl (meth)acrylate are preferable, and 2-hydroxyethyl (meth)acrylate, methyl (meth)acrylate, and n-butyl (meth)acrylate are more preferable.

Moreover, the acrylic block copolymer is preferably the block copolymer obtained by carrying out copolymerization of at least methyl (meth)acrylate, more preferably the block copolymer obtained by carrying out copolymerization of 2-hydroxyethyl (meth)acrylate, 2-hydroxypropyl (meth)acrylate, 4-hydroxybutyl (meth)acrylate, ethyl (meth)acrylate, n-propyl (meth)acrylate, isopropyl (meth)acrylate and/or n-butyl (meth)acrylate, by using methyl (meth)acrylate as an essential component, yet more preferably the block copolymer obtained by copolymerization of n-butyl (meth)acrylate, by using methyl (meth)acrylate as an essential component.

Furthermore, among these, the acrylic block copolymer is preferably poly(methyl methacrylate)-poly(n-butyl acrylate)-poly(methyl methacrylate)triblock copolymer, poly(methyl methacrylate)-poly(n-butyl methacrylate)-poly(methyl methacrylate)triblock copolymer, and poly(methyl methacrylate)-poly(n-butyl acrylate)diblock copolymer, and particularly preferably poly(methyl methacrylate)-poly(n-butyl acrylate)-poly(methyl methacrylate)triblock copolymer.

Moreover, the ratio of monomer units derived from methyl methacrylate in a single block of the acrylic block copolymer with respect to the total weight of the block is preferably 80 mass % or more, more preferably 90 mass % or more, and particularly preferably 95 to 100 mass %. In addition, the ratio of monomer units derived from the n-butyl acrylate in a single block of the acrylic block copolymer with respect to the total weight of the block is preferably 80 mass % or more, more preferably 90 mass % or more, and particularly preferably 95 to 100 mass %. Styrene-based thermoplastic elastomer

Examples of the styrene-based thermoplastic elastomer include a block copolymer of a polymer block (hard segment) mainly containing a styrene-based monomer-derived monomer unit and a polymer block (soft segment) mainly containing a conjugated diene compound-derived monomer unit, and one in which the conjugated diene compound-derived monomer unit of the block copolymer is hydrogenated.

Examples of the styrene-based monomer include styrene and a styrene derivative in which any site is substituted by at least one substituent (a halogen atom (F, Cl, Br, I), an alkyl group having 1 to 10 carbon atoms, an alkoxy group having 1 to 10 carbon atoms). Specific examples thereof include styrene, a-methylstyrene, vinyltoluene, and t-butylstyrene, and among them styrene is preferable.

Examples of the conjugated diene compound include butadiene, isoprene, chloroprene, and 2,3-dimethylbutadiene, and among them butadiene and isoprene are preferable.

Only one type thereof may be used, or two or more types thereof may be used in combination.

Specific examples of the styrene-based thermoplastic elastomer include a styrene-butadiene-styrene copolymer (SBS), a styrene-isoprene-styrene copolymer (SIS), a styrene-ethylene/butylene-styrene copolymer (SEBS), a styrene-ethylene/propylene-styrene copolymer (SEPS), a styrene-ethylene-ethylene/propylene-styrene copolymer (SEEPS), and among them SIS, SBS, and SEBS are preferable, and SBS is yet more preferable. Polyester-based thermoplastic elastomer

Preferred examples of the polyester-based thermoplastic elastomer include a block copolymer formed by block copolymerization of a hard segment formed from a constituent unit represented by Formula (I) and a soft segment formed from a constituent unit represented by Formula (II).

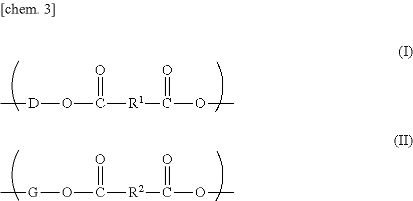

In Formula (I) and Formula (II), D denotes a divalent aliphatic residue having a molecular weight of no greater than 250, and is preferably a straight-chain or branched alkylene group having 1 to 20 carbon atoms, and more preferably a straight-chain alkylene group having 2 to 6 carbon atoms.

R¹ denotes an aromatic ring-containing divalent residue having a molecular weight of no greater than 300, and is preferably a phenylene group, which may have a substituent. Examples of the substituent include an alkyl group having 1 to 10 carbon atoms, an aryl group having 6 to 20 carbon atoms, an alkoxy group having 1 to 10 carbon atoms, a halogen atom (F, Cl, Br, I), an amino group, an alkylamino group having an alkyl group having 1 to 10 carbon atoms, and a dialkylamino group.

G denotes a divalent residue formed by removing a hydroxy group from the two terminals of a poly(alkylene oxide) glycol having an average molecular weight of 400 to 3,500.

R² denotes a divalent residue having a molecular weight of no greater than 300, and denotes an alkylene group having 1 to 30 carbon atoms or an arylene group having 6 to 30 carbon atoms. R² may have the substituent described for R¹.

Furthermore, in the present invention, a block copolymer formed by block copolymerization of a hard segment comprising a constituent unit represented by Formula (I′) and a soft segment comprising a constituent unit represented by Formula (II′) is preferable.

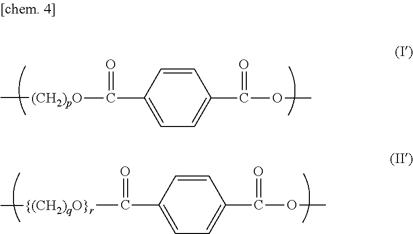

In Formula (I′), p denotes an integer of 1 to 4, and from the viewpoint of availability of materials it is preferably 2 or 4.

In Formula (II′), q denotes an integer of 1 to 10, and from the viewpoint of availability of materials it is preferably 2 to 4.

r denotes an integer of 1 to 500, and from the viewpoint of flexibility and rubber elasticity being exhibited it is preferably 5 to 100.

In the present invention, it is particularly preferable that an aromatic polyester comprising a constituent unit represented by Formula (I′) above is tetramethylene terephthalate, and an aliphatic polyether comprising a constituent unit represented by Formula (II′) above is an alkylene ether terephthalate. Specific examples include a polybutylene terephthalate/polytetramethylene ether glycol terephthalate block copolymer. Olefin-based thermoplastic elastomer

The olefin-based thermoplastic elastomer is one in which a polyolefin resin as a hard segment and an olefin-based elastomer as a soft segment form a multiphase.

The polyolefin as a hard segment is preferably polyethylene or polypropylene.

The olefin-based elastomer as a soft segment is preferably a copolymer formed from a monomer unit derived from ethylene and a constituent unit derived from an α-olefin unit having at least 3 carbon atoms.

Examples of the α-olefin unit having at least 3 carbon atoms include constituent units derived from α-olefins such as propylene, 1-butene, 2-methyl-1-butene, 3-methyl-1-butene, 1-pentene, 4-methyl-1-pentene, 1-hexene, 1-octene, 1-decene, and 1-octadecene.

Specific examples of the olefin-based elastomer include an ethylene-propylene random copolymer, an ethylene-butene random copolymer, an ethylene-hexene random copolymer, an ethylene-octene random copolymer, an ethylene-decene random copolymer, and an ethylene-4-methylpentene random copolymer, and among them an ethylene-propylene random copolymer and an ethylene-butene random copolymer are preferable. Ethylene-(meth)acrylate ester-based thermoplastic elastomer

With regard to the ethylene-(meth)acrylate ester-based thermoplastic elastomer, examples thereof include a block copolymer comprising a polymer block (hard segment) mainly containing ethylene and a polymer block (soft segment) derived from a (meth)acrylate ester.

Examples of the (meth)acrylate ester include methyl (meth)acrylate, ethyl (meth)acrylate, n-butyl (meth)acrylate, isobutyl (meth)acrylate, isopentyl (meth)acrylate, n-hexyl (meth)acrylate, isooctyl (meth)acrylate, 2-ethylhexyl (meth)acrylate, n-octyl (meth)acrylate, isononyl (meth)acrylate, n-decyl (meth)acrylate, and isodecyl (meth)acrylate. These constituent units may be contained on their own or as a mixture of two or more types.

Furthermore, a terpolymer comprising a constituent unit derived from carbon monoxide in addition to the constituent units derived from ethylene and a (meth)acrylate ester is also preferable as an ethylene-(meth)acrylate ester-based thermoplastic elastomer.

Specific examples of the ethylene-(meth)acrylate ester-based thermoplastic elastomer include an ethylene/n-butyl acrylate/carbon monoxide copolymer and an ethylene/decyl acrylate/carbon monoxide copolymer, and among them an ethylene/n-butyl acrylate/carbon monoxide copolymer is preferable.

### Polyamide-Based Thermoplastic Elastomer

As a polyamide-based thermoplastic elastomer, a multiblock copolymer comprising a polyamide as a hard segment and a polyester diol or polyether diol, which have a low glass transition temperature, as a soft segment can be cited as an example.

Here, examples of the polyamide component include nylon-6, -66, -610, -11, and -12, and among them nylon-6 and nylon-12 are preferable.

Examples of the polyether diol include poly(oxytetramethylene) glycol and poly(oxypropylene) glycol.

Examples of the polyester diol include poly(ethylene-1,4-adipate) glycol, poly(butylene-1,4-adipate) glycol, and polytetramethylene glycol. Specific examples of the polyamide-based elastomer include a nylon 12/polytetramethylene glycol block copolymer.

The resin composition for laser engraving of the present invention may comprise only one type of Component C or two or more types thereof in combination.

The content of Component C is preferably 10 to 95 mass % relative to the total solids content of the resin composition, more preferably 20 to 90 mass %, and yet more preferably 30 to 80 mass %.

As Component C, commercially available products can also be employed, and examples include TR-2000 (manufactured by JSR), LIR-50, LA2250 (both manufactured by Kuraray Co., Ltd.), UBEPOL BR 150L (manufactured by Ube Industries, Ltd.).

### (Component D) Radical Polymerization Initiator

The resin composition for laser engraving of the present invention comprises (Component D) a radical polymerization initiator in order to promote formation of a crosslinked structure.

As the radical polymerization initiator of the present invention, either a thermopolymerization initiator or a photopolymerization initiator may be used, and those known to a person skilled in the art may be used without limitations. Detailed descriptions are given below but the present invention should not be construed as being limited by these descriptions.

In the present invention, preferable polymerization initiators include (a) aromatic ketones, (b) onium salt compounds, (c) organic peroxides, (d) thio compounds, (e) hexaallylbiimidazole compounds, (f) ketoxime ester compounds, (g) borate compounds, (h) azinium compounds, (i) metallocene compounds, (j) active ester compounds, (k) compounds having a carbon halogen bond, and (I) azo compounds. Hereinafter, although specific examples of the (a) to (I) are cited, the present invention is not limited to these.

In the present invention, when applies to the relief-forming layer of the flexographic printing plate precursor, from the viewpoint of engraving sensitivity and making a favorable relief edge shape, (a) aromatic ketones, (c) organic peroxides and (I) azo compounds are more preferable, (a) aromatic ketones and (c) organic peroxides are yet more preferable, and (c) organic peroxides are particularly preferable.

The (a) aromatic ketones, (b) onium salt compounds, (d) thio compounds, (e) hexaallylbiimidazole compounds, (f) ketoxime ester compounds, (g) borate compounds, (h) azinium compounds, (i) metallocene compounds, (j) active ester compounds, and (k) compounds having a carbon halogen bonding may preferably include compounds described in paragraphs 0074 to 0118 of JP-A-2008-63554.

Moreover, (c) organic peroxides and (I) azo compounds preferably include the following compounds.

### (a) Aromatic Ketones

Preferred examples of the (a) aromatic ketones as a polymerization initiator that can be used in the present invention include benzophenone- or alkylphenone-based ones such as benzophenone, 4,4′-bis(dimethylamino)benzophenone, 4,4′-bis(diethylamino)benzophenone, 4,4′-dichlorobenzophenone, 1-hydroxycyclohexylphenylketone, 2-benzyl-2-(dimethylamino)-4′-morpholinobutyrophenone, 2-tolyl-2-(dimethylamino)-1-(4-morpholinophenyl)-1-butanone, 2-methyl-4′-(methylthio)-2-morpholinopropiophenone, and among them alkylphenone-based ones are more preferable, and t-1-hydroxycyclohexylphenylketone is yet more preferable.

### (c) Organic Peroxide

Preferred examples of the (c) organic peroxide as a polymerization initiator that can be used in the present invention include peroxyester-based ones such as 3,3′,4,4′-tetra(t-butylperoxycarbonyl)benzophenone, 3,3′,4,4′-tetra(t-amylperoxycarbonyl)benzophenone, 3,3′,4,4′-tetra(t-hexylperoxycarbonyl)benzophenone, 3,3′,4,4′-tetra(t-octylperoxycarbonyl)benzophenone, 3,3′,4,4′-tetra(cumylperoxycarbonyl)benzophenone, 3,3′,4,4′-tetra(p-isopropylcumylperoxycarbonyl)benzophenone, di-t-butyldiperoxyisophthalate, t-butylperoxybenzoate, t-butylperoxy-3-methylbenzoate, t-butylperoxylaurate, t-butylperoxypivalate, t-butylperoxy-2-ethyl hexanoate, t-butylperoxy-3,5,5-trimethylhexanoate, t-butylperoxyneoheptanoate, t-butylperoxyneodecanoate, and t-butylperoxyacetate, α,α′-di(t-butylperoxy)diisopropylbenzene, t-butylcumylperoxide, di-t-butylperoxide, t-butylperoxyisopropylmonocarbonate, and t-butylperoxy-2-ethylhexylmonocarbonate, and among them peroxyester-based ones are more preferable, and t-butylperoxybenzoate is yet more preferable.

### (l) Azo Compounds

Preferable (l) azo compounds as a polymerization initiator that can be used in the present invention include those such as 2,2′-azobisisobutyronitrile, 2,2′-azobispropionitrile, 1,1′-azobis(cyclohexane-1-carbonitrile), 2,2′-azobis(2-methylbutyronitrile), 2,2′-azobis(2,4-dimethylvaleronitrile), 2,2′-azobis(4-methoxy-2,4-dimethylvaleronitrile), 4,4′-azobis(4-cyanovaleric acid), dimethyl 2,2′-azobis(isobutyrate), 2,2′-azobis(2-methylpropionamideoxime), 2,2′-azobis[2-(2-imidazolin-2-yl)propane], 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N-butyl-2-methylpropionamide), 2,2′-azobis(N-cyclohexyl-2-methylpropionamide), 2,2′-azobis[N-(2-propenyl)-2-methyl-propionamide], 2,2′-azobis(2,4,4-trimethylpentane).

As the polymerization initiator in the present invention, the organic peroxide (c) is preferable from the viewpoint of crosslinkability of the resin composition and, moreover, is particularly preferable from the viewpoint of improvement of engraving sensitivity, which is an unexpected effect.

From the viewpoint of engraving sensitivity, a mode in which the organic peroxide (c) is combined with, as Component A, a macromonomer having a glass transition temperature (Tg) of at least normal temperature (20° C.) is particularly preferable. When there are a plurality of Tgs in a measurement, there may be at least one Tg that is 20° C. or above, but it is preferable for a Tg that is 20° C. or below not to be measured.

In the present invention, with regard to the radical polymerization initiator, one type thereof may be used on its own or two or more types may be used in combination.

In the present invention, the content of Component D in the resin composition for laser engraving is preferably 0.01 to 40 mass % relative to the total solids content, more preferably 0.05 to 30 mass %, yet more preferably 0.1 to 20 mass %, and particularly preferably 0.1 to 10 mass %.

Furthermore, as Component D a commercial product may be used, and examples thereof include Perbutyl Z (NOF Corporation) and Irgacure 184 (Ciba-Geigy Ltd.).

The resin composition for laser engraving of the present invention comprises Component A to Component D as essential components and may comprise another component. Examples of the other component include, but are not limited to, (Component E) a photothermal conversion agent, and (Component F) a solvent.

### (Component E) Photothermal Conversion Agent

The resin composition for laser engraving of the present invention preferably comprises a photothermal conversion agent, and more preferably comprises the photothermal conversion agent that can absorb light having a wavelength of 700 nm to 1,300 nm. It is surmised that the photothermal conversion agent absorbs laser light and generates heat thus promoting thermal decomposition of a cured material of the resin composition for laser engraving of the present invention during laser engraving. Because of this, it is preferable to select a photothermal conversion agent that absorbs light having the wavelength of the laser that is used for engraving.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximum absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific preferable examples include dyes having a maximum absorption wavelength from 700 nm to 1,300 nm, and such preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes.

In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saisin Ganryo Ouyogijutsu’ (Latest Applications of Pigment Technology) (CMC Publishing, 1986), ‘Insatsu Inki Gijutsu’ (Printing Ink Technology) CMC Publishing, 1984).

Examples of the type of pigment include black pigments, yellow pigments, orange pigments, brown pigments, red pigments, violet pigments, blue pigments, green pigments, fluorescent pigments, metal powder pigments, and other polymer-bonding colorants. Specific examples include insoluble azo pigments, azo lake pigments, condensed azo pigments, chelate azo pigments, phthalocyanine-based pigments, anthraquinone-based pigments, perylene and perinone-based pigments, thioindigo-based pigments, quinacridone-based pigments, dioxazine-based pigments, isoindolinone-based pigments, quinophthalone-based pigments, dyed lake pigments, azine pigments, nitroso pigments, nitro pigments, natural pigments, fluorescent pigments, inorganic pigments, and carbon black. Among these pigments, carbon black is preferable.

Any carbon black, regardless of classification by ASTM and application (e.g. for coloring, for rubber, for dry cell, etc.), may be used as long as dispersibility, etc. in the composition is stable. Carbon black includes for example furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products.

In the present invention, it is possible to use carbon black having a relatively low specific surface area and a relatively low DBP (dibutyl phthalate) absorption and also finely divided carbon black having a large specific surface area. Preferred examples of carbon black include Printex (registered trademark) U, Printex (registered trademark) A, Spezialschwarz (registered trademark) 4 (Degussa), and #45L (Mitsubishi Chemical Corporation).

The carbon black that can be used in the present invention has preferably a DBP absorption number of less than 150 mL/100 g, more preferably no greater than 100 mL/100 g, and yet more preferably no greater than 70 mL/100 g.

From the viewpoint of improving engraving sensitivity by efficiently transmitting heat generated by photothermal conversion to the surrounding polymer, etc., the carbon black is preferably a conductive carbon black having a specific surface area of at least 100 m²/g.

The above-mentioned carbon black may be acidic or basic carbon black. The carbon black is preferably basic carbon black. It is of course possible to use a mixture of different carbon blacks.

When carbon black is used as the photothermal conversion agent, thermal crosslinking is more preferable in point of the curability of the film, instead of the photo crosslinking using UV light etc., and, by the combination with the organic peroxide as the polymerization initiator, which is the aforementioned preferable component for use in combination, the engraving sensitivity becomes extremely high, more preferably.

In the resin composition for laser engraving of the present invention, it is preferable that the polymerization initiator and the photothermal conversion agent capable of absorbing light having a wavelength of 700 to 1,300 nm be used in combination, and it is particularly preferable that the organic peroxide and carbon black be used in combination. In the above embodiment, during laser engraving, the polymerization initiator remaining in the crosslinked relief-forming layer is decomposed by heat generated from the photothermal conversion agent to promote the decomposition of Component A or the like, thereby improving the engraving sensitivity.

Component E in the resin composition for laser engraving of the present invention may be used singly or in a combination of two or more compounds.

The content of the photothermal conversion agent capable of absorbing light having a wavelength of 700 to 1,300 nm in the resin composition for laser engraving of the present invention largely depends on the size of the molecular extinction coefficient characteristic to the molecule, and is preferably 0.01 to 20 mass % relative to the total solids content of the resin composition, more preferably 0.05 to 15 mass %, and yet more preferably 0.1 to 10 mass %.

### (Component F) Solvent

The resin composition for lazer engraving of the present invention may comprise (Component F) a solvent.

From the viewpoint of dissolving, a solvent used when preparing the resin composition for laser engraving of the present invention is preferably mainly an aprotic organic solvent. The aprotic organic solvent may be used on its own or may be used in combination with a protic organic solvent. More specifically, they are used preferably at aprotic organic solvent/protic organic solvent=100/0 to 50/50 (ratio by weight), more preferably 100/0 to 70/30, and particularly preferably 100/0 to 90/10.

Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Furthermore, among these, Component F is preferably propylene glycol monomethyl ether acetate as the aprotic organic solvent.

### <Other Additives>

The resin composition for laser engraving of the present invention may comprise as appropriate various types of known additives other than Component A to Component F as long as the effects of the present invention are not inhibited. Examples include a wax, a process oil, a metal oxide, an antiozonant, an anti-aging agent, a thermopolymerization inhibitor, and a colorant, and one type thereof may be used on its own or two more types may be used in combination.

In the resin composition for laser engraving of the present invention, as an additive for improving engraving sensitivity, it is preferable that a nitrocellulose or highly heat-conductive material be added.

The nitrocellulose is a self-reactive compound, during laser engraving, the nitrocellulose itself generates heat to assist the thermal decomposition of the binder polymer such as a coexisting hydrophilic polymer. As a result, it is assumed that engraving sensitivity is improved.

The highly heat-conductive material is added for the purpose of assisting heat conduction, and examples of the heat-conductive material include an inorganic compound such as metal particles and an organic compound such as a conductive polymer. As the metal particles, small gold particles, small silver particles, and small copper particles having a particle size in the order of micrometers to several nanometers are preferable. As the conductive polymer, a conjugated polymer is particularly preferable, and specific examples thereof include polyaniline and polythiophene.

In addition, by using a co-sensitizer, the sensitivity when the resin composition for laser engraving is cured by light is further improved.

Further, during the production and preservation of composition, it is preferable that a small amount of thermal polymerization inhibitor be added for preventing unnecessary thermal polymerization of the polymerizable compound.

For the purpose of coloring the resin composition for laser engraving, colorant such as dye or pigment may be added. Accordingly, properties such as visibility of the image section and aptitude for an image density measuring machine can be improved.

### <Content of Each Component>

As the content of each component relative to the solids content total mass of the resin composition for laser engraving of the present invention, preferably, component A is 5 to 20 mass %, component B is 8 to 30 mass %, component C is 20 to 90 mass %, component D is 0.05 to 30 mass %, and component E is 0 to 15 mass %, and more preferably, component A is 10 to 20 mass %, component B is 10 to 20 mass %, component C is 30 to 80 mass %, component D is 0.1 to 10 mass %, and component E is 0 to 10 mass %.

### (Flexographic Printing Plate Precursor for Laser Engraving)

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

In the present invention, the ‘flexographic printing plate precursor for laser engraving’ means both or one of a plate having a crosslinkable relief-forming layer formed from the resin composition for laser engraving in a state before being crosslinked and a plate in a state in which it is cured by light and/or heat.

In the present invention, the ‘relief-forming layer’ means a layer in a state before being crosslinked, that is, a layer formed from the resin composition for laser engraving of the present invention, which may be dried as necessary.

When a printing plate precursor having a crosslinked relief-forming layer is laser-engraved, the “flexographic printing plate” is produced.

In the present invention, the ‘crosslinked relief-forming layer’ means a layer formed by crosslinking the relief-forming layer. The crosslinking is preferably carried out by means of heat and/or light. Furthermore, the crosslinking is not particularly limited as long as it is a reaction by which the resin composition is cured, and it is a concept that includes a structure crosslinked due to reactions between Component B's, but it is preferable to form a crosslinked structure by a reaction between Component B and other Component.

The ‘ flexographic printing plate’ is prepared by laser engraving a printing plate precursor having a crosslinked relief-forming layer.

Moreover, in the present invention, the ‘relief layer’ means a layer of the flexographic printing plate formed by engraving using a laser, that is, the crosslinked relief-forming layer after laser engraving.

A flexographic printing plate precursor for laser engraving of the present invention comprises a relief-forming layer formed from the resin composition for laser engraving of the present invention, which has the above-mentioned components. The (crosslinked) relief-forming layer is preferably provided above a support.

The (crosslinked) flexographic printing plate precursor for laser engraving may further comprise, as necessary, an adhesive layer between the support and the (crosslinked) relief-forming layer and, above the relief-forming layer, a slip coat layer and a protection film.

### <Relief-Forming Layer>

The relief-forming layer is a layer formed from the resin composition for laser engraving of the present invention and is preferably a heat-crosslinkable layer.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate making or printing or may be placed and immobilized thereon, and a support is not always required.

A case in which the relief-forming layer is mainly formed in a sheet shape is explained as an example below.

### <Support>

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. PET (polyethylene terephthalate), PBT (polybutylene terephthalate), or PAN (polyacrylonitrile)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### (Process for Producing Flexographic Printing Plate Precursor for Laser Engraving)

Formation of a relief-forming layer in the flexographic printing plate precursor for laser engraving is not particularly limited, and examples thereof include a method in which the resin composition for laser engraving is prepared, solvent is removed as necessary from this resin composition for laser engraving, and it is melt-extruded onto a support. Alternatively, a method may be employed in which the resin composition for laser engraving is cast onto a support, and this is dried in an oven to thus remove solvent from the resin composition.

Among them, the process for making a flexographic printing plate for laser engraving of the present invention is preferably a production process comprising a layer formation step of forming a relief-forming layer from the resin composition for laser engraving of the present invention and a crosslinking step of crosslinking the relief-forming layer by means of heat and/or light to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for making the flexographic printing plate precursor for laser engraving of the present invention preferably comprises a layer formation step of forming a relief-forming layer from the resin composition for laser engraving of the present invention.

Preferred examples of a method for forming a relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove the solvent.

The resin composition for laser engraving may be produced by, for example, dissolving Component A to Component D, and as optional components Component E in an appropriate solvent. Since it is necessary to remove most of the solvent component in a stage of producing a flexographic printing plate precursor, it is preferable to use as the solvent a volatile low-molecular-weight alcohol (e.g. methanol, ethanol, n-propanol, isopropanol, propylene glycol monomethyl ether), etc., and adjust the temperature, etc. to thus reduce as much as possible the total amount of solvent to be added.

The thickness of the (crosslinked) relief-forming layer in the flexographic printing plate precursor for laser engraving before and after crosslinking is preferably at least 0.05 mm but no greater than 10 mm, more preferably at least 0.05 mm but no greater than 7 mm, and yet more preferably at least 0.05 mm but no greater than 3 mm.

### <Crosslinking Step>

The process for producing a flexographic printing plate precursor for laser engraving of the present invention is preferably a production process comprising a crosslinking step of crosslinking the relief-forming layer by means of light and/or heat to thus obtain a flexographic printing plate precursor having a crosslinked relief-forming layer, and more preferably a production process comprising a crosslinking step of crosslinking the relief-forming layer by heat.

The relief-forming layer may be crosslinked by heating the flexographic printing plate precursor for laser engraving (step of crosslinking by means of heat). As heating means, there can be cited a method in which a printing plate precursor is heated in a hot air oven or a far-infrared oven for a predetermined period of time and a method in which it is put into contact with a heated roller for a predetermined period of time.

Due to the relief-forming layer being crosslinked by heating, firstly, a relief formed after laser engraving becomes sharp and, secondly, tackiness of engraving residue formed when laser engraving is suppressed.

In addition, since by using a photopolymerization initiator or the like, the polymerizable compound is polymerized to form a crosslink, the crosslinking may be further carried out by means of light.

When the relief-forming layer comprises a photopolymerization initiator, the relief-forming layer may be crosslinked by irradiating the relief-forming layer with actinic radiation that triggers the photopolymerization initiator.

It is preferable to apply light to the entire surface of the relief-forming layer. Examples of the light (also called ‘actinic radiation’) include visible light, UV light, and an electron beam, but UV light is most preferably used. When the side where there is a substrate, such as a relief-forming layer support, for fixing the relief-forming layer, is defined as the reverse face, only the front face need be irradiated with light, but when the support is a transparent film through which actinic radiation passes, it is preferable to further irradiate the reverse face with light as well. When a protection film is present, irradiation from the front face may be carried out with the protection film as it is or after peeling off the protection film. Since there is a possibility of polymerization being inhibited in the presence of oxygen, irradiation with actinic radiation may be carried out after superimposing a polyvinyl chloride sheet on the relief-forming layer and evacuating.

### (Flexographic Printing Plate and Process for Making Same)

The process for making a flexographic printing plate of the present invention comprises a layer formation step of forming a relief-forming layer from the resin composition for laser engraving of the present invention, a crosslinking step of crosslinking the relief-forming layer by means of heat and/or light to thus obtain a flexographic printing plate precursor having a crosslinked relief-forming layer, and an engraving step of laser-engraving the flexographic printing plate precursor having the crosslinked relief-forming layer.

The flexographic printing plate of the present invention is a flexographic printing plate having a relief layer obtained by crosslinking and laser-engraving a layer formed from the resin composition for laser engraving of the present invention, and is preferably a flexographic printing plate made by the process for making a flexographic printing plate of the present invention.

The flexographic printing plate of the present invention is preferably used when an aqueous ink is printed.

The layer formation step and the crosslinking step in the process for making a flexographic printing plate of the present invention mean the same as the layer formation step and the crosslinking step in the above-mentioned process for producing a flexographic printing plate precursor for laser engraving, and preferred ranges are also the same.

### <Engraving Step>

The process for making a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked by irradiation with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is further preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, and ‘Applied Laser Technology’ The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited.

### <Other Steps>

The process for making a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid containing water as a main component.

Drying step: a step of drying the engraved relief layer.

Post-crosslinking step: a step of further crosslinking the relief layer by applying energy to the engraved relief layer.

After the above steps, a rinsing step of washing off engraving residue by rinsing the engraved surface with water or a liquid containing water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin flexographic printing plate precursor, and when slime due to engraving residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, yet more preferably no greater than 13.2, particularly preferably no greater than 13, and most preferably no greater than 12.5. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraving residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, amphoteric surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total weight of the rinsing liquid, and more preferably 0.05 to 10 mass %.

The flexographic printing plate of the present invention having a relief layer on the surface of any substrate such as a support etc. may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured at 25° C. by a durometer (a spring type rubber hardness meter) that presses an indenter (called a pressing needle or indenter) into the surface of a measurement target so as to deform it, measures the amount of deformation (indentation depth), and converts it into a numerical value.

The flexographic printing plate of the present invention is particularly suitable for printing by a flexographic printer using an aqueous ink, but printing is also possible when it is carried out by a relief printer using any of aqueous, oil-based, and UV inks, and printing is also possible when it is carried out by a flexographic printer using a UV ink. The flexographic printing plate of the present invention has excellent rinsing properties, there is no engraving residue, since a relief layer obtained has excellent elasticity aqueous ink transfer properties and printing durability are excellent, and printing can be carried out for a long period of time without plastic deformation of the relief layer or degradation of printing durability.

In accordance with the present invention, there can be provided a resin composition for laser engraving that can give a flexographic printing plate having excellent engraved shape, ink laydown, and printing durability, a flexographic printing plate precursor for laser engraving and a process for producing same, and a flexographic printing plate and a process for making same.

### EXAMPLES

Hereinafter, the present invention will be described in further detail with reference to Examples, but the present invention is not limited to Examples. Furthermore, ‘parts’ and ‘%’ in the description below mean ‘parts by mass’ and ‘mass %’ unless otherwise specified. Here, weight-average molecular weights (Mw) and number-average molecular weights (Mn) of compounds in Examples indicate values measured by gel permeation chromatography (GPC) (eluent: tetrahydrofuran) unless specified otherwise.

Details of Component A to Component E used in Examples and Comparative Examples are as follows.

### (Component A) Macromonomer Comprising Only One Radically Polymerizable Group in Molecule

A-1: AS-6 (Toagosei Co., Ltd.), polystyrene skeleton, Tg>20° C., Mw=6,000
A-2: AA-6 (Toagosei Co., Ltd.), polymethyl methacrylate skeleton, Tg>20° C., Mw=6,000
A-3: AA-714 (Toagosei Co., Ltd.), polymethyl methacrylate/poly(2-hydroxyethyl methacrylate) (86/14) copolymer skeleton, Tg>20° C., Mw=6,000
A-4: AB-6 (Toagosei Co., Ltd.), polybutyl acrylate skeleton, Tg<20° C., Mw=6,000
A-5: lauryl methacrylate, molecular weight 254.4
A-6: stearyl methacrylate (Wako Pure Chemical Industries, Ltd.), molecular weight 338.6
A-7: styrene (Tokyo Chemical Industry Co., Ltd.), molecular weight 104.2
A-8: XMAP C/M type (Kaneka Corporation), difunctional acrylic liquid resin, Tg<20° C., Mn=20,000

### (Component B) Polyfunctional Ethylenically Unsaturated Compound Comprising Two or More Radically Polymerizable Groups in Molecule

1,6-Hexanediol diacrylate (HDDA, Dai-Ichi Kogyo Seiyaku Co., Ltd.)
Trimethylolpropane triacrylate (A-TM PT, Shin-Nakamura Chemical Co., Ltd.)

### (Component C) Binder Polymer

C-1: TR-2000 (JSR), styrene.butadiene thermoplastic elastomer, Tg=about −80° C. and about 100° C.
C-2: LIR-50 (Kuraray Co., Ltd.), Tg=−63° C., liquid polyisoprene, Mn=54,000, plastomer
C-3: UBEPOL BR 150L (Ube Industries, Ltd.), polybutadiene rubber, Mn=243,000, plastomer, Tg=about −80° C.
C-4: LA2250 (Kuraray Co., Ltd.), polymethyl methacrylate-b-poly(n-butyl acrylate)-b-polymethyl methacrylate block copolymer, thermoplastic elastomer, Mw=67,000, Tg=about −30° C. and about 130° C.

### (Component D) Radical Polymerization Initiator

D-1: Perbutyl Z (NOF Corporation, t-butyl peroxybenzoate)
D-2: Irgacure 184 (Ciba-Geigy Ltd., 1-hydroxycyclohexyl phenyl ketone)

### (Component E) Photothermal Conversion Agent

Carbon black #45L (Mitsubishi Chemical Corporation, particle size: 24 nm, specific surface area: 125 m²/g, DBP oil adsorption: 45 cm³/100 g)

### Examples 1 to 10 and Comparative Examples 1 to 5

### 1. Preparation of Resin Composition for Laser Engraving

A three-necked flask equipped with a stirring blade and a condenser was charged with 64 parts of Component C described in Table 1 and 50 parts of propylene glycol monomethyl ether acetate as a solvent, and was heated at 70° C. for 180 minutes while stirring to thus dissolve Component C.

Subsequently, the solution was set at 40° C., 10 parts of Component A described in Table 1, 15 parts of Component B, 1 part of Component D, and 10 parts of Component E described in Table 1 were added thereto, and stirring was carried out for 30 minutes. Here, a component denoted by ‘none’ in Table 1 was not added.

This operation gave a coating solution for a flowable crosslinkable relief-forming layer (resin composition for laser engraving).

### 2. Preparation of Flexographic Printing Plate Precursor for Laser Engraving

A spacer (frame) having a predetermined thickness was placed on a polyethylene terephthalate (PET) substrate, the resin composition obtained was gently cast so that it did not overflow from the spacer (frame), and dried in an oven at 70° C. for 3 hours. Subsequently, thermal crosslinking was carried out by heating at 80° C. for 3 hours and at 100° C. for a further 3 hours to thus provide a crosslinked relief-forming layer having a thickness of about 1 mm, thus producing a flexographic printing plate precursor for laser engraving. In Example 10, in which Component D was a photopolymerization initiator, instead of thermal crosslinking optical crosslinking was carried out with UV irradiation from an ultra high pressure mercury lamp.

### 3. Preparation of Flexographic Printing Plate for Laser Engraving

After the spacer and the PET were removed and detached from the flexographic printing plate precursor for laser engraving, the crosslinked relief-forming layer was subjected to engraving by means of the two types of lasers below so as to have recessed lines and raised lines having a width of 100 μm at intervals of 100 μm in a 1 cm square and to raster engraving of a solid printed area in another 1 cm square, thus giving a flexographic printing plate.

In Examples 1 and 10, in which the resin composition did not comprise a photothermal conversion agent, engraving by laser irradiation was carried out by employing, as a carbon dioxide laser engraving machine, an ML-9100 series high quality CO₂ laser marker (Keyence). Engraving was carried out using the carbon dioxide laser engraving machine under conditions of an output of 12 W, a head speed of 200 mm/sec, and a pitch setting of 2,400 DPI.

In Examples 2 to 9, in which the resin composition comprised a photothermal conversion agent, as a semiconductor laser engraving machine, laser recording equipment provided with an SDL-6390 fiber-coupled semiconductor laser (FC-LD) (JDSU, wavelength 915 nm) with a maximum power of 8.0 W was used. Engraving was carried out using the semiconductor laser engraving machine under conditions of a laser output of 7.5 W, a head speed of 409 mm/sec, and a pitch setting of 2,400 DPI.

The laser engraved flexographic printing plate was subjected to the rinsing step below.

### <Preparation of Rinsing Liquid>

Preparation of a rinsing liquid was carried out by adding a 48% aqueous solution of NaOH (Wako Pure Chemical Industries, Ltd.) to 500 parts of pure water while stirring so as to adjust the pH to 13.

Subsequently, Softazoline LAO (lauramidopropyldimethylamine oxide, Kawaken Fine Chemicals Co., Ltd.) was added at 0.1 mass % of the total mass and stirred for 30 minutes, thus producing a rinsing liquid.

### <Rinsing Step>

The rinsing liquid prepared by the above method was dropped (about 100 mL/m²) by means of a pipette onto a plate material engraved by the above-mentioned method so that the plate surface became uniformly wet, was allowed to stand for 1 min, and rubbed using a toothbrush (Clinica Toothbrush Flat, Lion Corporation) 20 times (30 sec) in parallel to the plate with a load of 200 gf (1.96N). Subsequently, the plate face was washed with running water, moisture of the plate face was removed, and it was naturally dried for approximately 1 hour.

The thickness of the relief layer of the flexographic printing plate obtained in each of Examples 1 to 10 and Comparative Examples 1 to 5 was about 1 mm.

### 4. Evaluation of Flexographic Printing Plate

Evaluation of the performance of the flexographic printing plate in terms of the items below was carried out, and the results are shown in Table 1.

### (4-1) Engraved Shape

Edge parts of the recessed lines and the raised lines produced under the above engraving conditions were visually examined using a VHX-1000 microscope (Keyence Corporation) at a magnification of 300×.

The evaluation criteria were as follows.

1: Engraved edge shape was sharp.
2: Engraved edge was slightly thermally melted but at a level causing no problem for printing.
3: Engraved edge was thermally melted.

### (4-2) Ink Laydown

A flexographic printing plate that had been obtained was set in a printer (Model ITM-4, IYO KIKAI SEISAKUSHO Co., Ltd.), as the ink Aqua SPZ16 Red aqueous ink (Toyo Ink Manufacturing Co., Ltd.) was used without dilution, and printing was carried out continuously using Full Color Form M 70 (Nippon Paper Industries Co., Ltd., thickness 100 μm) as the printing paper, and the degree of ink attachment in a solid printed area on the printed material 1,000 m from the start of printing was compared by visual inspection.

The evaluation criteria were as follows.

1: Uniform with no uneven density
2: Slightly uneven density but at a level causing no problem in practice
3: Some uneven density

### (4-3) Printing Durability

Printing was continued under the same conditions as those for the ink laydown test, and 1% to 10% highlights were checked for the printed material. Completion of printing was defined as being when a halftone dot was not printed, and the length (meters) of paper printed up to the completion of printing was used as an index. The larger the value, the better the evaluation of printing durability.

TABLE 1

| | | | | | | Engraved | Ink | Printing |
|---|---|---|---|---|---|---|---|---|
| | Component A | Component B | Component C | Component D | Component E | shape | laydown | durability(m) |
| Ex. 1 | A-1 | HDDA | C-1 | D-1 | None | 1 | 1 | 120,000 |
| Ex. 2 | A-1 | HDDA | C-1 | D-1 | Carbon Black #45L | 1 | 1 | 140,000 |
| Ex. 3 | A-1 | HDDA | C-2 | D-1 | Carbon Black #45L | 1 | 1 | 90,000 |
| Ex. 4 | A-1 | HDDA | C-3 | D-1 | Carbon Black #45L | 1 | 1 | 100,000 |
| Ex. 5 | A-2 | HDDA | C-1 | D-1 | Carbon Black #45L | 1 | 1 | 110,000 |
| Ex. 6 | A-3 | HDDA | C-1 | D-1 | Carbon Black #45L | 1 | 1 | 120,000 |
| Ex. 7 | A-2 | HDDA | C-4 | D-1 | Carbon Black #45L | 1 | 1 | 115,000 |
| Ex. 8 | A-4 | HDDA | C-1 | D-1 | Carbon Black #45L | 2 | 1 | 90,000 |
| Ex. 9 | A-1 | A-TMPT | C-1 | D-1 | Carbon Black #45L | 1 | 1 | 130,000 |
| Ex. 10 | A-1 | HDDA | C-1 | D-2 | None | 1 | 1 | 75,000 |
| Comp. Ex. 1 | None | HDDA | C-1 | D-1 | Carbon Black #45L | 3 | 3 | 70,000 |
| Comp. Ex. 2 | A-5 | HDDA | C-1 | D-1 | Carbon Black #45L | 3 | 2 | 65,000 |
| Comp. Ex. 3 | A-6 | HDDA | C-1 | D-1 | Carbon Black #45L | 3 | 2 | 60,000 |
| Comp. Ex. 4 | A-7 | HDDA | C-1 | D-1 | Carbon Black #45L | 1 | 3 | 60,000 |
| Comp. Ex. 5 | A-8 | HDDA | C-1 | D-1 | Carbon Black #45L | 3 | 1 | 80,000 |

1. A resin composition for laser engraving, comprising
(Component A) a macromonomer comprising only one radically polymerizable group in the molecule,
(Component B) a polyfunctional ethylenically unsaturated compound comprising two or more radically polymerizable groups in the molecule,
(Component C) a binder polymer, and
(Component D) a radical polymerization initiator.

2. The resin composition for laser engraving according to claim 1, wherein Component A comprises a monomer unit derived from one type of ethylenically unsaturated compound selected from the group consisting of styrenes and (meth)acrylic acid esters.

3. The resin composition for laser engraving according to claim 1, wherein Component A has a weight-average molecular weight of at least 2,000 but no greater than 20,000.

4. The resin composition for laser engraving according to claim 1, wherein Component A has a glass transition temperature (Tg) of at least 20° C.

5. The resin composition for laser engraving according to claim 2, wherein Component A has a glass transition temperature (Tg) of at least 20° C.

6. The resin composition for laser engraving according to claim 4, wherein Component D is an organic peroxide.

7. The resin composition for laser engraving according to claim 1, wherein the radically polymerizable group of Component A is a (meth)acryloyl group at a molecular terminal.

8. The resin composition for laser engraving according to claim 5, wherein the radically polymerizable group of Component A is a (meth)acryloyl group at a molecular terminal.

9. The resin composition for laser engraving according to claim 1, wherein it further comprises (Component E) a photothermal conversion agent.

10. The resin composition for laser engraving according to claim 1, wherein Component C is a plastomer.

11. The resin composition for laser engraving according to claim 1, wherein Component C is a thermoplastic elastomer.

12. The resin composition for laser engraving according to claim 9, wherein Component D is an organic peroxide and Component E is carbon black.

13. A flexographic printing plate precursor for laser engraving, comprising above a support a relief-forming layer comprising the resin composition for laser engraving according to claim 1.

14. A flexographic printing plate precursor for laser engraving, comprising above a support a crosslinked relief-forming layer formed by crosslinking by means of heat and/or light a relief-forming layer comprising the resin composition for laser engraving according to claim 1.

15. The flexographic printing plate precursor for laser engraving according to claim 13, wherein it comprises a crosslinked relief-forming layer that has been crosslinked by means of heat.

16. A process for producing a flexographic printing plate precursor for laser engraving, comprising
a layer formation step of forming a relief-forming layer comprising the resin composition for laser engraving according to claim 1, and
a crosslinking step of crosslinking the relief-forming layer by means of heat and/or light to thus obtain a flexographic printing plate precursor comprising a crosslinked relief-forming layer.

17. The process for producing a flexographic printing plate precursor for laser engraving according to claim 16, wherein in the crosslinking step the relief-forming layer is crosslinked by means of heat.

18. A process for making a flexographic printing plate, comprising
a step of preparing the flexographic printing plate precursor for laser engraving according to claim 13, and
an engraving step of laser-engraving the flexographic printing plate precursor for laser engraving to thus form a relief layer.

19. The process for making a flexographic printing plate according to claim 18, wherein subsequent to the engraving step it further comprises a rinsing step of rinsing a surface of the relief layer with an aqueous rinsing liquid.

20. A flexographic printing plate made by the process according to claim 18.
